(19) United States
(12) Patent Application Publication
(10) Pub. No.: US 2007/0113626 A1
(43) Pub. Date: May 24, 2007

(54) Method of measuring the flexibility of a golf club shaft

(76) Inventor: Steve Silvey, Cumming, GA (US)

Correspondence Address: WELSH & FLAXMAN LLC, 2000 DUKE STREET, SUITE 100, ALEXANDRIA, VA, 22314, US

(21) Appl. No.: 11/284,011

(22) Filed: Nov. 22, 2005

(51) Int. Cl. G01M 1/00

(52) U.S. Cl. 73/65.01

(57) ABSTRACT

A method of measuring the frequency characteristics of a golf club shaft by taking measurements at a plurality of predetermined locations along the length of the shaft being measured. These measurements are used to determine the overall characteristics of the shaft. This method enables shafts to be matched at each measurement location in order to perform in a similar, if not identical manner when used by a golfer to execute golf shots.

### BACKGROUND OF THE INVENTION

The present invention relates to a method of measuring the flexibility of a golf club shaft, and more particularly, to, a method of measuring the frequency of the shaft along its entire length.

In order for a golfer to obtain consistent golf ball flight for his personal swing parameters, it has been found that the physical characteristics of the shaft must be consistent from one club to the next club. The flexibility and the torque characteristics of a shaft along its entire length must be consistent between each golf club in order to provide consistent velocity of the club head as it strikes the ball in order to result in similar golf ball flight patterns. Typically golf club shafts are made of varying flexes depending upon the skill level of the particular golfer. Generally, a highly skilled golfer, such as a golf professional, uses a relatively stiff shaft of limited flexibility, whereas golfers with progressively lesser skills use golf club shafts of increased flexibility. Typically, shafts are made of light weight steel or of a composite material such as carbon fibers in an epoxy matrix. Shafts made with carbon and epoxy are known in the industry as graphite shafts and are made by winding carbon material around a form or by collating piles of uncured pre-preg composite material and subsequently curing the same. During the manufacture of these types of shafts, variations in the materials as well as in the preparation steps, such as wrapping and seam location of the materials, make it quite difficult to exactly replicate the overall flex of each golf shaft from one shaft to another. Therefore in order to match shafts, it becomes necessary to measure each shaft and assign a stiffness value thereto. Typically this is done by using a frequency analyzing machine to determine the exact frequency of the shaft. Such a machine and the method of using the same are disclosed in U.S. Pat. No. 5,040,279 to Braly. As disclosed in this patent and typically in the club making art, the frequency of a shaft is measured by clamping the butt end of the shaft and measuring the oscillations of the free end of the shaft with an electronic counter unit by simply bending the shaft and allowing it to vibrate in a wobbling pattern once the shaft is let go in close proximity to the electronic unit.

This method has been found generally acceptable for determining the overall frequency of the shaft, which frequency value is a measure of the shaft flex or stiffness. It has been found when the measurement is made with only the butt end of the shaft clamped, the overall frequency of the shaft may be similar, but the frequency values along the length of the shaft do not necessarily match. This variance along the length of the shaft creates discrepancies in the performance of the shaft during execution of a golf shot.

Another patent of interest is U.S. Pat. No. 5,952,580 to Haas for an apparatus and method for producing shaft having preselected lengths and flexural properties. After an initial measurement to determine the longitudinal deformation characteristics of the shaft, it is then repositioned in the clamp to a second location to provide the desired longitudinal deformation characteristics.

U.S. Pat. No. 6,546,802 to Shiraishi et al. describes a method for evaluating a golf club shaft which measures the vibrations of the rear portion of the shaft while the tip portion is fastened.

### SUMMARY OF THE INVENTION

The present invention is a method of measuring the flexibility of a golf club shaft using a standard frequency measuring machine at a plurality of locations along its entire length in order to more precisely match shafts to each other. As is commonly practiced using conventional shaft frequency measuring machines, a frequency measurement is made with the butt end of the shaft clamped in the machine. This produces a single reading, conventionally measured in cycles per second, within the range of 215-225 cps for a relatively soft or flexible shaft to 275 cps for a relatively stiff shaft. As indicated above, with conventional practice this single reading normally would be used to determine the overall stiffness of the shaft. However, the overall single frequency measurement of the shaft does not reflect the way a particular shaft will preform at various locations along the length of the shaft. Rather the butt frequency measurement is representative of the relative flexibility or stiffness at the butt end of the shaft. For example, a shaft with a stiffer butt end may have a softer tip end or have a stiff tip end with a soft intermediate section. Each of these shafts performs differently even if the butt end frequency measures the same.

Golfers have different swings that exert different forces on a golf shaft as a golf club is swung. For example a golfer who prefers a flexible feel at the hands location needs a stiffer flex toward the bottom of the shaft. A golfer who prefers a softer more flexible feel toward the club head needs a shaft that is stiffer near the butt end in order to maintain an overall selected shaft frequency. For this reason, a golfer wanting to match an entire set of clubs or replace a broken shaft, most often will not be successful when only the butt end of a shaft to be matched is measured.

In the practice of the present invention, a shaft may be measured either connected to a golf club head or non-connected. In performing the method of the present invention, measurements are taken at a plurality of predetermined locations along the length of the shaft being measured. In this way, the overall characteristics of the shaft are measured, not only the butt end. This method has been found that shafts may be matched in order to perform in a similar, if not identical manner when used by a golfer to execute golf shots.

In addition to a measurement at the butt end of the shaft, other locations where the shaft is to be measured preferably are determined using a template chart with the locations marked or printed thereon in inches, at three separate locations along a length of the template. In performing the method of the present invention, a first frequency measurement is made at the butt end of the golf club. This is the same measurement as described hereinabove with respect to the conventional way of using a frequency measurement machine. The subsequent measurement locations along the length of a shaft are determined using the template chart by aligning the butt end of the club or shaft with the right-hand end of the template. Twelve inches from the butt end, along the length of the template, is a line that represents the second shaft measurement location. With the shaft positioned on the template chart, the shaft is used corresponding to the first location on the template. Typically, a suitable marking pen or small piece of tape adhered to the shaft can be used for the mark. A third frequency measurement location is marked eight inches further, or a total of twenty inches from the right-hand butt end of the template chart. With the shaft in place, a second mark is made on the shaft. The final frequency measurement location on the template chart is located seven and ½ inches from the left-hand end of the template chart. This measurement location is marked in the shaft from the tip end after aligning the top of the hosel of the club head with the left edge of the template chart and placing the shaft on the chart. If the shaft is not fixed to a club head, it becomes necessary to insert the tip end of the shaft into an open hosel of an unattached club head in order to obtain the final measurement location. Thus, using the template, each shaft is measured precisely at the same location along its longitudinal length.

Once the shaft is marked using the template chart, the shaft is placed in the standard frequency measurement machine. A first measurement is taken with the butt end of the shaft clamped in the frequency measuring machine. The shaft is then clamped at the second frequency measurement location and the frequency again measured. The shaft is clamped at the third frequency measurement location and a third measurement is taken. Finally, the shaft is measured at the final frequency measurement location seven and ½ inches from the top of the hosel of the club head at the end of the shaft opposite the butt end. The four frequency measurements are recorded. These measurements represent the structural properties of the shaft throughout its entire length.

Preferably a number of shafts are measured in this way and marked accordingly. This creates an inventory whereby a club maker may simply match all the frequency values between shafts to obtain a match. If the numbers are close, or preferably matched exactly, it can be safely assumed that the shaft will perform in the same way as the original shaft to be matched. If the measurements of the unknown shaft do not match, it becomes necessary to find another shaft and continue the measuring and matching effort until a suitable match is found. Preferably the measurements are recorded directly on the shaft itself at a suitable location, such as just adjacent the bottom or under the bottom of the grip. This provides a permanent record of the properties of the particular shaft. The frequencies may be coded with a suitable number system that corresponds with a prepared chart in order that exact frequency numbers need not be recorded directly on the shaft.

Any shaft that does not provide a suitable match may be kept in inventory with the measurements marked for future use. When enough shafts are inventoried, it is easier to find an exact match so that it may not always be necessary to measure unknown shafts.

A primary object of the present invention is the provision of a method for measuring the frequency of the golf club shaft along its entire length to facilitate a matching of one golf shaft to another.

These and other objects of the invention may be appreciated by referring to the following description and accompanying drawings.

### BRIEF DESCRIPTION OF THE DRAWINGS

FIG. 1 illustrates a schematic representation of a golf club shaft being measured at a first butt end location.

FIG. 2 illustrates a golf club shaft being measured at a second location.

FIG. 3 illustrates a shaft being measured at a third location.

FIG. 4 illustrates a shaft being measured at a fourth location.

FIG. 5 illustrates a template used in the shaft frequency measuring process.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as the basis for the claims and as a basis for teaching one skilled in the art how to make and/or use the invention.

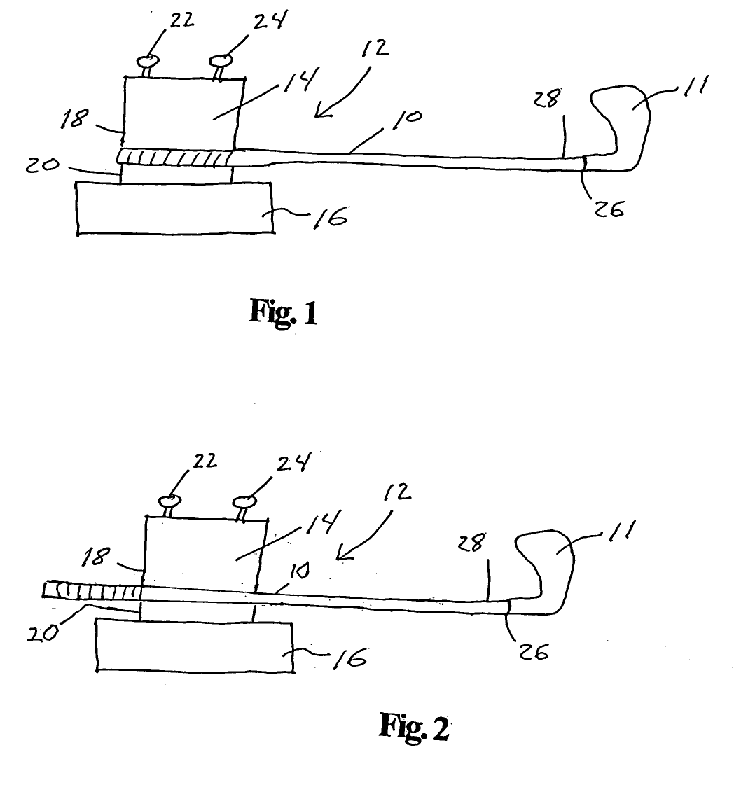

In accordance with the present invention, a golf club shaft 10 is measured either before or after the shaft is connected to a golf club head 11. With reference to FIGS. 1 to 4, the measurements are taken by a frequency measurement machine 12 including a clamp 14 and an electronic frequency detector 16. The clamp 14 is formed of a pair of shaped jaws 18 and 20 and a pair of screws 22 and 24 to tighten the clamp on a golf club shaft 10 being measured. Measurements are taken at a plurality of predetermined locations, a first measurement being taken at the butt end 26 of the shaft 10, and subsequent measurements being taken along the length of the shaft toward the tip end 28 of the shaft 10. Referring to FIG. 5, a template 50, having a predetermined number of measurement locations marked thereon, is used in the practice of the present invention. The template 50 is designed with the butt end location on the right edge 52 of the template 50. A second location 54 is marked twelve inches from the right end 52 and a third location 56 is marked twenty inches from the right hand end 52 of the template 50. A fourth location 58 is marked seven and ½ inches from the left end 60 of the template 50. With the butt end of the shaft 10 at the right-hand end 52 of the template, a mark twelve inches along the length of the shaft 10 is marked corresponding to the second shaft measurement location 54. The shaft 10 is typically marked with a pen or a piece of tape or the like. A third frequency measurement location is marked another eight inches further along the length of the shaft 10.

The top of the hosel 26 of the club head 11 is aligned with the left end 60 of the template 50 and the fourth location is marked on the shaft seven and ½ inches from the edge of the hosel 26 near the tip end 28 of the shaft 10. This is the final measurement location. If the shaft 10 is not attached to a club head 11, the final location is determined by inserting the tip end 28 of the shaft 10 into an unattached club head 11 so the exact location of the upper end of the hosel can be determined.

As illustrated in FIG. 1, a first measurement is made of a shaft 10 using the frequency measurement machine 12. The shaft 10 is placed in the clamp 14 and the shaft 10 is clamped at the butt end 26 thereof. The electronic frequency measuring detector 16 measures the vibration pattern of the shaft 10 as it oscillates by manually bending and releasing the shaft 10. These frequency measurement detector 16 are well known in the prior art and form no part of the present invention.

FIG. 2 illustrates a second step of the method of the present invention. The shaft 10 is placed under the electronic frequency measuring detector 16 away from the butt end 26 toward the tip end 28 to the marked point 12 inches along the length of the shaft 10 and clamped at that location. As with the first measurement, the second measurement is measured by the electronic frequency measuring detector 16 and recorded.

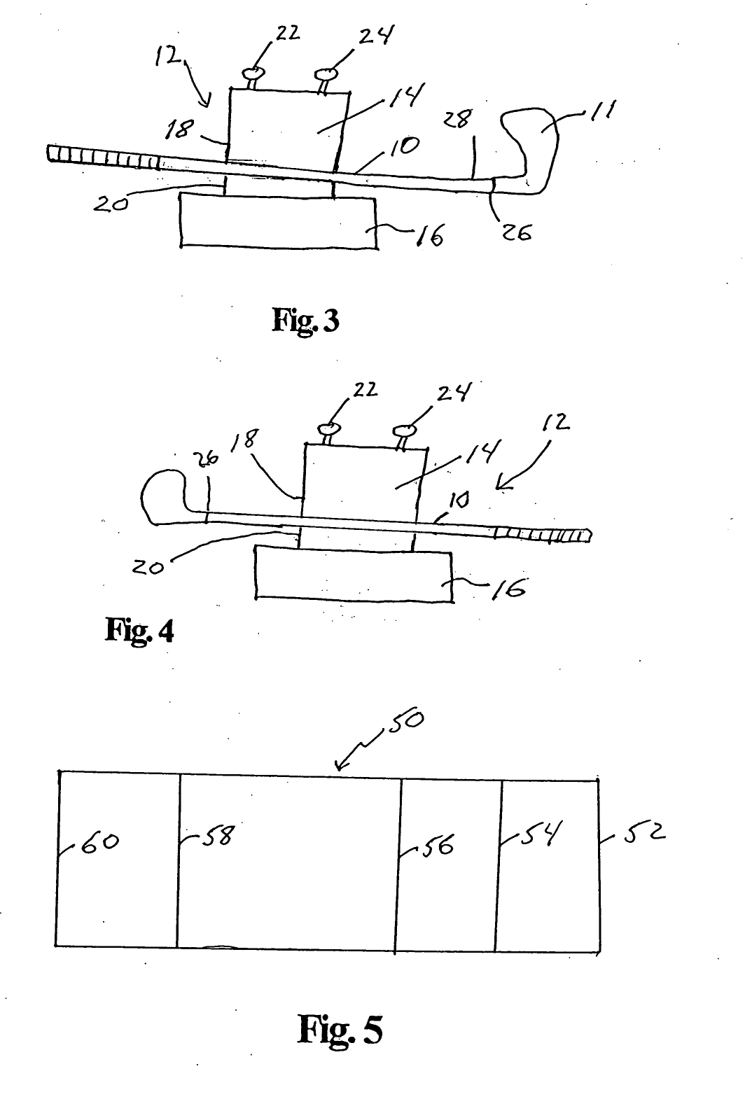

FIG. 3 illustrates another step in the method of the present invention. The shaft 10 is moved to the third measurement location marked on the shaft 10 toward the tip end 26 and another measurement is taken and recorded.

FIG. 4 illustrates a final measurement step. The shaft 10 is reversed relative to the frequency measurement apparatus 12 and the last pre measured measurement location on the shaft 10 near the tip end 26 of the shaft 10 is secured by the clamp 14. A measurement is made by the frequency measurement detector 16 and recorded.

After taking the four measurements, they are recorded, preferably on a small label that is attached to the shaft. Once the frequency measurements are recorded, a comparison step may be made to match the frequency measurements on the measured shaft with measurements on similar pre-measured shafts to obtain a match.

By taking measurements at four different locations on the shaft 10, a club maker is able to determine the characteristics along the entire length of the shaft 10, not just the butt end characteristics. When a match is found, there is a very high likelihood of the two shafts performing in the same way.

Assuming an entire golf club set has been previously matched, each of the four measurements on each golf club will match other clubs in the set. Thereafter, should one of the shafts be broken or damaged, a matching shaft from inventory or found by measuring a plurality of shafts can then be used as a replacement.

Typically a golfer who finds a favorite golf club is able to provide a matching back up club using the frequency matching technique described here and above.

It would be appreciated that the measurement method may be used with shafts of any length and any flexibility. The only requirement is that a plurality of measurements be taken along the entire length of the shaft to ensure that the flexibility characteristics are measured at multiple locations. Further, it will be appreciated that more than four measurements may be taken, although it has been found that four measurements are a significant number to enable an exact match to be found.

While the preferred embodiment has been shown and described, it will be understood that there is no intent to limit the invention by such disclosure, but rather, is intended to cover all modifications and alternate constructions falling within the spirit and scope of the invention.

1. A method of measuring the flexibility of a golf club shaft comprising the steps of: taking a first frequency measurement with a frequency analyzing machine with a butt end of the shaft clamped in said machine, and taking a plurality of subsequent frequency measurements with said frequency analyzing machine with the shaft clamped at successive locations spaced from the butt end of the shaft spaced along the length of the shaft progressively further from the butt end toward a tip end thereof.

2. The method of claim 1 further including the step of recording said frequency measurements for comparison with other shafts having frequency measurements taken at the same locations.

3. The method of claim 1 further including the step of using a pre-measured template to determine said successive locations along the length of the shaft.

4. The method of claim 1 wherein said successive locations include at least two locations at pre-measured distances from the butt end of the shaft.

5. The method of claim 4 wherein said successive locations include at least one location measured approximate the tip end of the shaft.

6. The method of claim 5 wherein said, at least one location approximate the tip end of the shaft is located at the upper edge of a club head hosel when attached on the shaft.

7. The method of claim 2 further including the step of comparing the shaft frequency measurements with similar frequency measurements on other shafts.

8. A method of measuring the flexibility of a golf club shaft comprising the steps of: taking a first frequency measurement with a frequency analyzing machine with a butt end of the shaft clamped in said machine; taking a plurality of subsequent frequency measurements with said frequency analyzing machines with the shaft clamped at successive locations spaced along the length of the shaft progressively further from the butt end; taking another frequency measurement at a location measured from the tip end of said shaft; and, recording said frequency measurements for comparison with other shafts having frequency measurements taken at the same locations.

9. A method of measuring the flexibility of a golf club shaft comprising the steps of: taking a first frequency measurement with a frequency analyzing machine with a butt end of the shaft clamped in said machine; taking a plurality of subsequent frequency measurements with said frequency analyzing machines with the shaft clamped at successive locations spaced along the length of the shaft progressively further from the butt end; taking another frequency measurement at a location measured from the tip end of the shaft; recording said frequency measurements for comparison with other shafts having frequency measurements taken at the same locations; and comparing said frequency measurements with other shafts having frequency measurements taken at the same locations.
